(19) United States
(12) Patent Application Publication
(10) Pub. No.: US 2008/0140942 A1
(43) Pub. Date: Jun. 12, 2008

(54) IMPLEMENTING A HOT COHERENCY STATE TO A CACHE COHERENCY PROTOCOL IN A SYMMETRIC MULTI-PROCESSOR ENVIRONMENT

(76) Inventors: Marcus L. Kornegay, Durham, NC (US); Ngan N. Pham, Raleigh, NC (US)

Correspondence Address: HOFFMAN WARNICK & DALESSANDRO LLC, 75 STATE STREET, 14TH FLOOR, ALBANY, NY, 12207, US

(21) Appl. No.: 11/609,510

(22) Filed: Dec. 12, 2006

(51) Int. Cl. G06F 12/08

(52) U.S. Cl. 711/146; 711/E12.026

(57) ABSTRACT

A computer system is provided that has a main memory and a plurality of processor agents each having a last level cache and a hot cache. Each processor agent is configured to store cache lines in the last level cache and the hot cache. The hot cache is configured to store cache lines in the hot coherency state. Cache lines in the hot coherency state are cache lines that have been read and modified. The hot cache is smaller in size than the last level cache to facilitate fast access to the cache lines in the hot coherency state in response to a future request to read with intent to modify. A bus connects each of the plurality of processor agents to the main memory.

### BACKGROUND

This disclosure relates generally to symmetric multi-processor (SMP) environments, and more specifically to implementing a hot coherency state to a cache coherency protocol for use in a SMP platform.

In general a SMP platform is a multi-processor computer architecture that has two or more identical processors connected to a single shared main memory. A typical SMP platform will rely on a cache coherency protocol to maintain the integrity of data in the platform by identifying certain states that cache lines can have at any point in time. One particular cache coherency protocol used in a SMP platform is the MESI protocol which has four states that can identify a cache line: M—Modified, E—Exclusive, S—Shared, and I—Invalid. A cache line is in the Modified state if it has been modified from the value in main memory by a processor. A cache line is in the Exclusive state if only one processor in the SMP has exclusive ownership to the cache line. A cache line is in the Shared state if it is stored in the caches of more than one processor. A cache line is in the Invalid state if it is not stored in the caches of any of the processors.

The MESI protocol is only one example of a cache coherency protocol available for use in a SMP platform. Other cache coherency protocols include but are not limited to MOSI, MOESI and MESIF protocols. The MOSI protocol has four states that can identify a cache line: M—Modified, O—Owned (i.e., a cache line is in the Owned state if it holds the most recent, correct copy of the data), S—Shared, and I—Invalid. The MOESI protocol has five states that can identify a cache line: M—Modified, O—Owned, E—Exclusive, S—Shared, and I—Invalid. The MESIF protocol has five states that can identify a cache line: M—Modified, E—Exclusive, S—Shared, I—Invalid, and F—Forward (i.e., a cache line is in the Forward state if it holds a copy of data in which copies can be made).

In a typical SMP platform, data transfers and modifications by processors occur very frequently. None of the currently available cache coherency protocols represent cache lines that have been frequently modified, therefore modified cache lines will pass from one processor to the next without any history of the modifications being passed along. As a result, a lot of time is spent writing cache lines to the caches in the processors and to main memory, which increases overall latency of the SMP platform and decreases performance of applications running on the platform.

### SUMMARY

Therefore, it would be desirable if there was a cache coherency protocol that could accommodate cache lines that have been modified by the processors in the SMP platform. Adding a state to represent modified cache lines would provide some history behind the modifications that could be used to track and manage these cache lines in such a way that improves latency and overall performance.

In one embodiment, there is a method of implementing a hot coherency state to a cache coherency protocol used in a multi-processor computer system having a plurality of processor agents, wherein each of the plurality of processor agents has at least one cache. In this embodiment, the method comprises issuing a snoop request for a cache line with intent to modify from one of the plurality of processor agents; determining whether the requested cache line is stored within the cache of one of the non-issuing plurality of processor agents; ascertaining whether the requested cache line has been read and modified if present in the cache of one of the non-issuing plurality of processor agents; designating the cache line as being in a hot coherency state in response to ascertaining that the cache line has been read and modified; forwarding the cache line in the hot coherency state to the processor agent that issued the snoop request for modification; and storing the modified cache line in the hot coherency state in the cache of the processor agent that modified the cache line to facilitate fast access to the cache line in response to a future request to read with intent to modify.

In another embodiment, there is a computer system that comprises main memory and a plurality of processor agents each having a last level cache and a hot cache. Each processor agent is configured to store cache lines in the last level cache and the hot cache. The hot cache is configured to store cache lines in the hot coherency state, wherein cache lines in the hot coherency state are cache lines that have been read and modified. The hot cache is smaller in size than the last level cache to facilitate fast access to the cache lines in the hot coherency state in response to a future request to read with intent to modify. A bus connects each of the plurality of processor agents to the main memory.

In a third embodiment, there is a computer-readable medium storing computer instructions for implementing a hot coherency state to a cache coherency protocol used in a multi-processor computer system having a plurality of processor agents, wherein each of the plurality of processor agents has at least one cache. In this embodiment, the computer instructions comprises issuing a snoop request for a cache line with intent to modify from one of the plurality of processor agents; determining whether the requested cache line is stored within the cache of one of the non-issuing plurality of processor agents; ascertaining whether the requested cache line has been read and modified if present in the cache of one of the non-issuing plurality of processor agents; designating the cache line as being in a hot coherency state in response to ascertaining that the cache line has been read and modified; forwarding the cache line in the hot coherency state to the processor agent that issued the snoop request for modification; and storing the modified cache line in the hot coherency state in the cache of the processor agent that modified the cache line to facilitate fast access to the cache line in response to a future request to read with intent to modify.

### BRIEF DESCRIPTION OF THE DRAWINGS

FIG. 1 shows a high-level schematic diagram of a SMP platform that implements a cache coherency protocol with a hot coherency state according to one embodiment of the disclosure; and

FIG. 2 shows an example of using a hot coherency state in a MESI cache coherency protocol with the SMP platform shown in FIG. 1.

### DETAILED DESCRIPTION

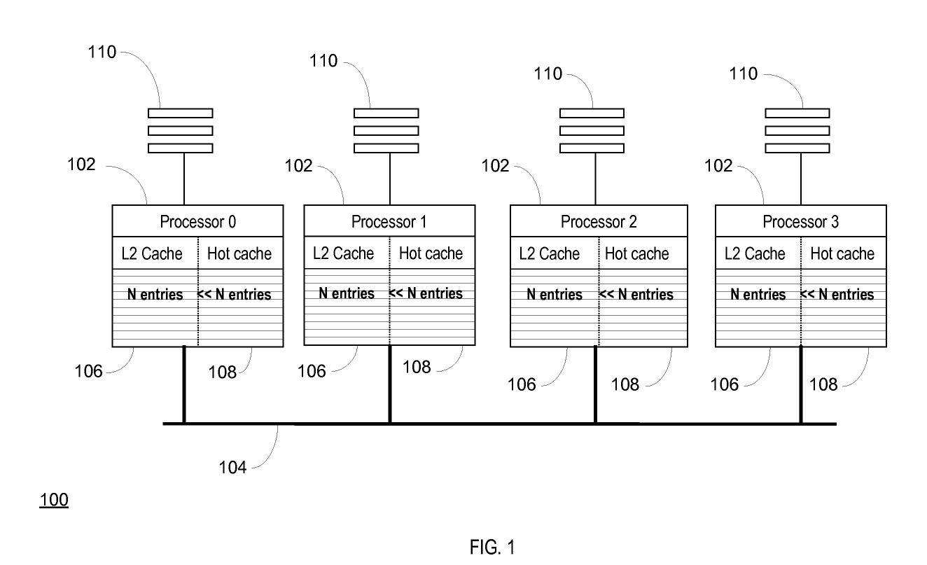

FIG. 1 shows a high-level schematic diagram of a SMP platform 100 that implements a cache coherency protocol with a hot coherency state according to one embodiment of the disclosure. In one embodiment, the SMP platform 100 is a multi-processor computer system that comprises a plurality of processor agents 102 interconnected by a bus 104. For illustrative purposes, FIG. 1 only shows a limited number of processor agents 102 (i.e., Processor Agent 0, Processor Agent 1, Processor Agent 2, and Processor Agent 3) to facilitate an understanding of the scope and content of this disclosure. Those skilled in the art will recognize that the SMP platform 100 may have more or less processor agents.

As shown in FIG. 1, each processor agent 102 has a last level cache 106 and a hot cache 108 to store cache lines. The last level cache 106 is shown in FIG. 1 as an L2 cache, however, it is not meant to be limiting. Those skilled in the art will recognize that other level caches can be used such as an L3 cache or L4 cache. The type of cache level will depend on the multi-level cache hierarchies that are in the processor agents 102. The hot cache 108 is configured to store cache lines in the hot coherency state. As used herein, cache lines in the hot coherency state are cache lines that have been read and modified by the processor agents 102. Both the L2 cache 106 and the hot cache 108 contain N entries to store cache lines. In one embodiment, the number of entries in the hot cache 108 is less than the number of entries in the L2 cache 106. Having fewer entries makes the hot cache 108 smaller in size than the L2 cache 106. Storing a cache line with a hot coherency state representation in the hot cache 108 will facilitate fast access to that cache line when another processor agent 102 makes a snoop request to that cache line with read with intent to modify (RWITM). Faster access to that cache line is possible because it can be stored within the hot cache 108 which is smaller in size, requiring less time to search, and because the cache line has been designated to be in a hot coherency state. Below is a more detailed discussion on identifying and designating cache lines in a hot coherency state and storing these hot cache lines in the hot cache 108.

FIG. 1 also shows that each processor agent 102 has a main memory 110 that the processor can access. Although FIG. 1 shows each processor agent 102 having their own memory 110, other configurations are possible. For example, in another embodiment, there may be only one shared memory 110 that each processor agent 102 has access to through bus 104.

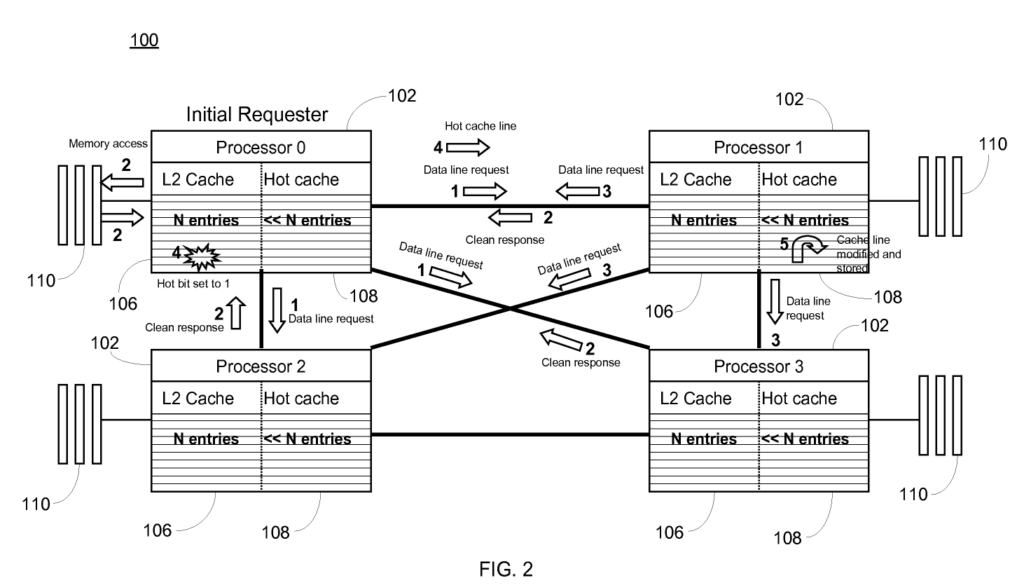

FIG. 2 shows an example of a using a hot coherency state in a MESI cache coherency protocol with the SMP platform 100 shown in FIG. 1. In the example shown in FIG. 2, Processor Agent 0 sends out a snoop request for a cache line with RWITM the cache line to all the other processor agents (i.e., Processor 1, Processor 2, and Processor 3) 102 in the SMP platform 100. This action is illustrated in FIG. 2 by the numeral 1. In addition to sending out the snoop request, the Processor Agent 0 will send out a request to memory 110 to look for the cache line.

In this example, the snoop responses come back from the other processor agents (Processor 1, Processor 2, and Processor 3) 102 clean or being in the Invalid state (i.e., not stored by the caches associated with the processor agents). Processor Agent 0 then accesses the cache line from main memory 110. Processor Agent 0 then modifies the cache line and stores it in its L2 cache 106. These actions are illustrated in FIG. 2 by the numeral 2.

Later in time, Processor Agent 1 sends out a snoop request for that same cache line with RWITM to the other processor agents (Processor 0, Processor 2, and Processor 3). These actions are illustrated in FIG. 2 by the numeral 3. In response to receiving the snoop request, Processor Agent 0 identifies that the cache line has been modified. Since Processor Agent 0 has modified the cache line, the cache line then is designated as being in a hot coherency state. As a result, Processor Agent 0 then sets a Hot bit to 1 which activates a Hit Hot (HitH) signal, and forwards the cache line in the hot coherency state to Processor Agent 1. In addition, Processor Agent 0 invalidates the cache line in the L2 cache 106 because that copy is no longer valid since Processor Agent 1 is going to modify that cache line. These actions are illustrated in FIG. 2 by the numeral 4.

After Processor Agent 1 receives the hot cache line, it will then modify the cache line and store it in the hot cache 108. These actions are illustrated in FIG. 2 with the numeral 5. Although this example shows the cache line stored in the hot cache 108 of Processor Agent 1, it is not meant to be limiting because the L2 cache 106 can store the cache line. A benefit to storing the cache line in the hot cache 108 is that it will facilitate fast access to the line the next time a processor agent 102 makes a snoop request with RWITM that data. As noted above, the hot cache is smaller in size as compared to the L2 cache, making it easy and quicker to search. In addition to the size of the hot cache 108 being smaller, the use of the hot coherency state to indicate that the cache line has been previously modified will help in quickly identifying the cache line within the SMP platform. As a result, latency is reduced and overall performance of the platform is improved.

Referring back to the example shown in FIG. 2, the actions described above and represented in the figures by numerals 1-5 will cycle again in similar fashion once another processor agent 102 within the SMP platform 100 makes a snoop request to RWITM that cache line. For example, if Processor 3 issues a snoop request to the cache line to RWITM, Processor 1 will identify that the cache line has been modified. Processor Agent 1 then designates the cache line as being in a hot coherency state and sets a Hot bit to 1 and forwards the cache line in the hot coherency state to Processor Agent 3. In addition, Processor Agent 1 will invalidate the cache line in the hot cache 108 because that copy is no longer valid since Processor Agent 3 is going to modify that cache line.

It is apparent that there has been provided with this disclosure, an approach for implementing a hot coherency state to a cache coherency protocol used in a symmetric multi-processor environment. While the disclosure has been particularly shown and described in conjunction with a preferred embodiment thereof, it will be appreciated that variations and modifications can be effected by a person of ordinary skill in the art without departing from the scope of the disclosure.

What is claimed is:

1. A method of implementing a hot coherency state to a cache coherency protocol used in a multi-processor computer system having a plurality of processor agents, wherein each of the plurality of processor agents has at least one cache, the method comprising:
issuing a snoop request for a cache line with intent to modify from one of the plurality of processor agents;
determining whether the requested cache line is stored within the cache of one of the non-issuing plurality of processor agents;
ascertaining whether the requested cache line has been read and modified if present in the cache of one of the non-issuing plurality of processor agents;
designating the cache line as being in a hot coherency state in response to ascertaining that the cache line has been read and modified;
forwarding the cache line in the hot coherency state to the processor agent that issued the snoop request for modification; and
storing the modified cache line in the hot coherency state in the cache of the processor agent that modified the cache line to facilitate fast access to the cache line in response to a future request to read with intent to modify.

2. The method according to claim 1, further comprising invalidating the cache line from the cache of the processor agent that forwarded the cache line in the hot coherency state.

3. A computer system, comprising:
main memory;
a plurality of processor agents each having a last level cache and a hot cache, wherein each processor agent is configured to stores cache lines in the last level cache and the hot cache, wherein the hot cache is configured to store cache lines in the hot coherency state, wherein cache lines in the hot coherency state are cache lines that have been read and modified, wherein the hot cache is smaller in size than the last level cache to facilitate fast access to the cache lines in the hot coherency state in response to a future request to read with intent to modify; and
a bus connecting each of the plurality of processor agents to the main memory.

4. The system according to claim 3, wherein each of the plurality of processor agents is configured to send out a snoop request for a cache line with read with intent to modify.

5. The system according to claim 3, wherein each of the plurality of processor agents is configured to identify a cache line in the last level cache or hot cache that has been read and modified in response to receiving a snoop.

6. The system according to claim 3, wherein each of the plurality of processor agents is configured to designate a cache line that has been read and modified as being in a hot coherency state.

7. The system according to claim 6, wherein each of the plurality of processor agents is configured to forward the cache line in the hot coherency state to a processor agent that issued a snoop request for the cache line.

8. A computer-readable medium storing computer instructions for implementing a hot coherency state to a cache coherency protocol used in a multi-processor computer system having a plurality of processor agents, wherein each of the plurality of processor agents has at least one cache, the computer instructions comprising:
issuing a snoop request for a cache line with intent to modify from one of the plurality of processor agents;
determining whether the requested cache line is stored within the cache of one of the non-issuing plurality of processor agents;
ascertaining whether the requested cache line has been read and modified if present in the cache of one of the non-issuing plurality of processor agents;
designating the cache line as being in a hot coherency state in response to ascertaining that the cache line has been read and modified;
forwarding the cache line in the hot coherency state to the processor agent that issued the snoop request for modification; and
storing the modified cache line in the hot coherency state in the cache of the processor agent that modified the cache line to facilitate fast access to the cache line in response to a future request to read with intent to modify.

9. The computer-readable medium according to claim 8, further comprising instructions for invalidating the cache line from the cache of the processor agent that forwarded the cache line in the hot coherency state.
